(19) United States
(12) Patent Application Publication
(10) Pub. No.: US 2010/0287023 A1
(43) Pub. Date: Nov. 11, 2010

(54) COLLABORATIVE VIEW FOR A GROUP PARTICIPATION PLAN

(75) Inventors: Yishai Knobel, Boston, MA (US); Robert F. Goodman, Allston, MA (US); John Reynolds Burkhardt, Arlington, MA (US); Katie Rae, Brookline, MA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/435,816

(22) Filed: May 5, 2009

(51) Int. Cl. G06Q 10/00; G06F 3/048; G06F 15/16

(52) U.S. Cl. 705/9; 715/753; 709/206; 709/204

(57) ABSTRACT

When a group of users engage in activities comprising multiple tasks shared amongst the group, difficulties may arise from tracking progress, facilitating communication, reconciling tasks, etc. Accordingly, as provided herein, a collaborative view for a group participation plan may be created. A group participation plan comprising one or more tasks and one or more participant identities may be received. A commitment plan may be created by allocating the one or more tasks to respective participant identities. The commitment plan may be presented within a collaborative view. The collaborative view may show overall group progress, individual progress, and/or other information relating to the completion of allocated tasks. The collaborative view may be updated based upon task progress. Participants may view and interact with the collaborative view (e.g., a web-based user interface). For example, a participant may track individual progress, group progress, and/or other participant's progress.

### BACKGROUND

Many activities involve multiple tasks distributed amongst a group of people. For example, a birthday party may involve one person purchasing decorations, another person purchasing food, and two other people setting up the birthday party. Unfortunately, it may be difficult to track task progress (e.g., who owes what, who did what, who needs to do what, overall group progress, etc.). Current user interfaces may allow electronic tracking of an activity (e.g., tracking an individual's finances and personal IOUs with other people, splitting tasks and money for social events, etc.).

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A technique for creating a collaborative view for a group participation plan is disclosed herein. A group participation plan comprising one or more tasks (e.g., buy cake for party, donate money for cake, bring balloons to party, etc.) and one or more participant identities (e.g., a participant's contact information) may be received. A commitment plan may be created by allocating one or more tasks to respective participant identities. For example, a participant identity may be notified of a suggested task allocation (e.g., an email asking Dan to bring the cake, a text message asking George to bring the balloons, etc.). The commitment plan may be created based upon user commitment feedback (e.g., Dan agrees to bring the cake, George cannot commit to bringing the balloons, therefore, a suggested task allocation may be sent to Angela to bring the balloons).

The commitment plan may be presented within a collaborative view (e.g., an interactive user interface). For example, the collaborative view may be presented to one or more participant identities (e.g., a participant may access a website presenting the collaborative view) within a web-based environment. The collaborative view may comprise a group total participation status (e.g., percentage of completion of all tasks) and a participation status of respective participant identities (e.g., progress of tasks allocated to Dan, due date of tasks allocated to Dan, comments on Dan's task progress, etc.). The commitment plan (e.g., group total participation status, participation status of a particular participant identity, a task progress comment, etc.) may be updated based upon progress of one or more tasks. For example, the commitment plan may be updated based upon a progress email from a participant identity, manual user input, notification from a third party (e.g., payment to a third party service), etc. Email notification may be sent to an organizer of the group participation plan and/or participant identities based upon an update of the commitment plan (e.g., a participant may be sent an email reminding them to complete their task on time, an organizer may be sent an email notifying them a participant completed a task, etc.).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of creating a collaborative view for a group participation plan.

FIG. 2 is a component block diagram illustrating an exemplary system for creating a collaborative view for a group participation plan.

FIG. 3 is an illustration of an example of creating a collaborative view for a group participation plan.

FIG. 4 is an illustration of an example of a collaborative view.

FIG. 5 is an illustration of an example of a collaborative view.

FIG. 6 is an illustration of an example of a collaborative view.

FIG. 7 is an illustration of an example of a collaborative view.

FIG. 8 is an illustration of an exemplary computer-readable medium wherein processor-executable instructions configured to embody one or more of the provisions set forth herein may be comprised.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

When a group of users engage in activities comprising multiple tasks shared amongst the group, difficulties may arise from tracking progress, managing commitments, reconciling tasks, etc. Current websites may offer the ability for an individual to track their finances and IOUs or plan a social event through an online interface. Unfortunately, many of these online interfaces lack transparency and peer pressure. It may be difficult for an organizer to facilitate communication, easily distribute burden amongst participants, provide transparent information about the activity's progress (e.g., who is accountable for what, how far along are participants, how far along is the group as a whole), and reconcile tasks (e.g., create peer pressure to facilitate reconciliation regardless of the situation), while mitigating social awkwardness and friction.

Among other things, a technique for creating a collaborative view for a group participation plan is provided herein. The collaborative view may be created and/or presented based upon assigning tasks to participants. The collaborative view may comprise transparent group progress and individual task progress that may be available to participants through a web-based environment. The collaborative view may be updated with comments (e.g., peer pressure comments, task progress, and/or other information). Participants may reconcile tasks through the collaborative view (e.g., send progress emails, manually update their progress status, and/or complete a task through a third party service). Communication may be facilitated through email notifications, instant message services, SMS, etc. For example, an email comprising a participation status may be sent to one or more participant identities (e.g., Dan has 3 days left to complete the remaining 30% of his task, Angela still owes $20 out of her original commitment of $50 for pizza, etc.).

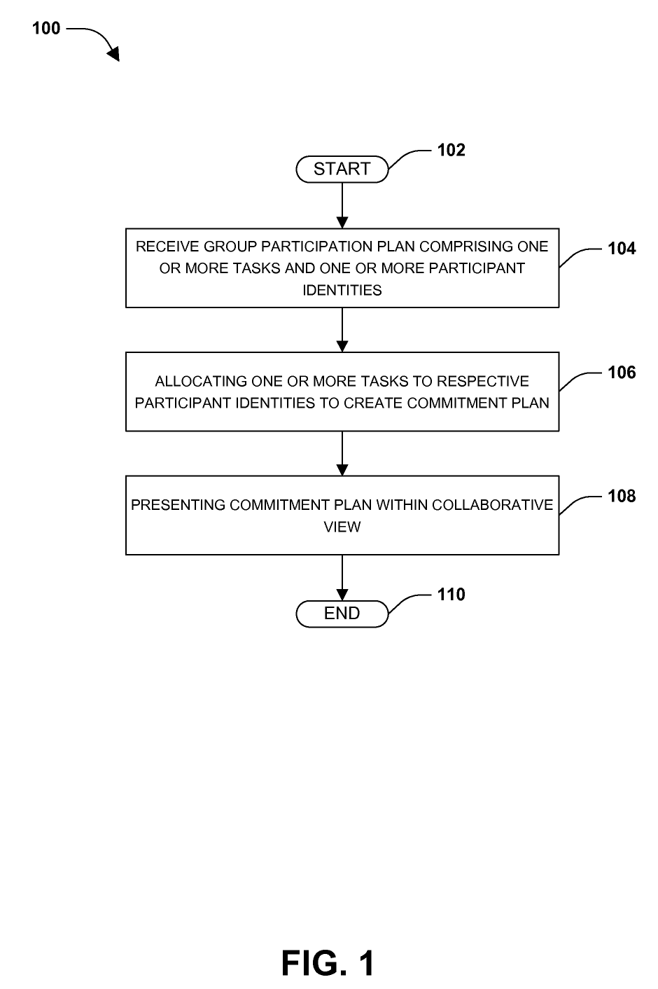

One embodiment of creating a collaborative view for a group participation plan is illustrated by an exemplary method 100 in FIG. 1. At 102, the method begins. At 104, a group participation plan comprising one or more tasks and one or more participant identities may be received. For example, the group participation plan may be received through an online service in which a user may be engaged. It may be appreciated that the one or more tasks may comprise a user specified mapping of the one or more tasks to the one or more participant identities (e.g., 30% of setting up the birthday party could be allocated to Dan and 70% could be allocated to George). That is, the user specified mapping may be taken into account when allocating tasks to create the commitment plan (e.g., a suggested task allocation may be derived from the mapping).

At 106, one or more tasks may be allocated to respective participant identities to create a commitment plan. For example, a participant identity may be notified with a suggested task allocation (e.g., an email requesting a participant to commit to a task). In one example the suggested task allocation may be automatically generated based upon a task allocation algorithm. In another example, the suggested task allocation may be derived from a user specified mapping. The commitment plan may be created based upon user commitment feedback regarding the suggested task allocation (e.g., the participant may accept, decline, or modify a commitment to a particular task). It may be appreciated that the commitment plan may be revised. For example, a task may be removed from the commitment plan because no participants committed to the task. In another example, if a participant declines to commit to a task, then other participants may be requested to commit to the task.

At 108, the commitment plan may be presented within a collaborative view. For example, the collaborative view may be presented within a web-based environment (e.g., as a webpage, as a user interface, etc.) available to one or more participant identities. Within the collaborative view, a group total participation status may be presented. The group total participation status allows the participants to monitor progress of the group as a whole (e.g., a group percentage showing how much task performance has been achieved). Within the collaborative view, a participation status of respective participant identities may be presented. The participation status may provide the progress of a particular task allocated to a participant, the overall completion of all tasks allocated to the participant, comments regarding the progress of the participant, and/or other information relevant to the progress and reconciliation of tasks. The participation status may facilitate peer pressure that may encourage users to timely complete tasks due to the fact that their progress is transparent to other participants through the collaborative view.

The commitment plan may be updated based upon progress with regard to one or more tasks (e.g., update a particular participant status, a group total participation status, a comment, etc.). The progress may be determined based upon manual user input. For example, a participant (e.g., an organizer) may manually update the commitment plan through the collaborative view. The progress may be determined based upon a progress email from a participant identity. For example, a progress email may be received from a user indicating a task has been completed; thereupon the task within the commitment plan may be updated. The progress may be determined based upon a notification from a third party service (e.g., a task relating to a payment may be completed through a third party payment service).

Email notification may be provided to participant identities (e.g., an organizer of an activity relating to the group participation plan). For example, an organizer may be notified through email of an update to the commitment plan. In another example, an email notification of a participation status may be sent to one or more participant identities. In yet another example, an email notification may be sent comprising a web-based invoice for payment of a money based task to one or more participant identities (e.g., a participant with a task corresponding to payment of money may be sent an email invoice indicating a technique for payment). The accessibility of the collaborative view and email notifications to participant identities may encourage timely participation, progress updates, and reconciliation (e.g., who owes whom, who needs to do what, etc.) without creating unnecessary social awkwardness and friction. At 110, the method ends.

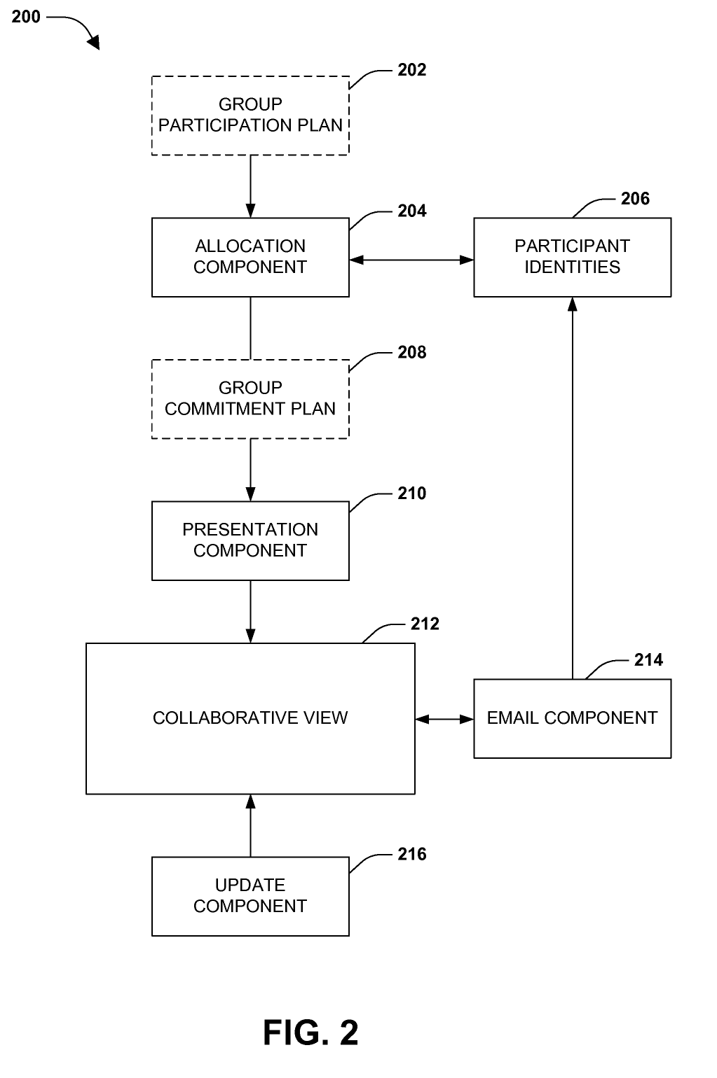

FIG. 2 illustrates an example 200 of a system configured for creating a collaborative view for a group participation plan. The system may comprise an allocation component 204 and a presentation component 210. The system may also comprise an email component 214 and/or an update component 216.

The allocation component 204 may be configured to receive a group participation plan 202 comprising one or more tasks and one or more participant identities. It may be appreciated that the one or more tasks may comprise a user specified mapping of tasks to participant identities. It may be appreciated that participant identities 206 may be a representation of a participant, such as, an email address. The allocation component 204 may be configured to allocate one or more tasks to respective participant identities 206 to create a commitment plan 208. For example the allocation component 204 may notify respective participant identities 206 of a suggested task allocation, wherein the respective participant identities 206 may accept, reject, and/or modify the suggested task allocation (e.g., instead of committing to $20 for pizza, Dan commits to $15 for pizza). The suggested task allocation may be derived from the group participation plan 202 (e.g., user specified mappings). The commitment plan 208 may be created based upon user commitment feedback regarding the suggested task allocation (e.g., accept, reject, modify, etc.). The commitment plan 208 may be revised due to modifying tasks, removing asks, reallocating tasks to different participant identities, etc.

The presentation component 210 may be configured to present the commitment plan within a collaborative view 212. For example, the collaborative view 212 may be a web-based user interface, which participant identities 206 (e.g., participants) may view and/or interact with the web-based user interface. A group total participation status and/or a participation status of respective participant identities 206 may be presented within the collaborative view 212. This allows participant identities 206 (e.g., participants) to track individual progress, group progress, other participant's progress, comments, and/or other information relating to the commitment plan.

The email component 214 may be configured to send an email notification of a participation status to one or more participant identities (e.g., participant identities 206). In one example, the email component 214 may send an email notification indicating how a participant identity may make an online payment to fulfill a task. In another example, the email component 214 may send an email notification providing a progress update (e.g., payment received and task complete). In yet another example, the email component 214 may send an email notification regarding the need to reconcile a task (e.g., Dan is only 20% complete and has 2 days to complete task), which may be used as peer pressure.

The update component 216 may be configured to update the commitment plan based upon progress with regard to one or more tasks. For example, the update component 216 may update one or more participation statuses and/or the group total participation status. The progress may be determined based upon manual user input within the collaborative view 212, notification of payment to a third party service, and/or notification from a participant identity of their particular progress with regard to a task (e.g., a progress email).

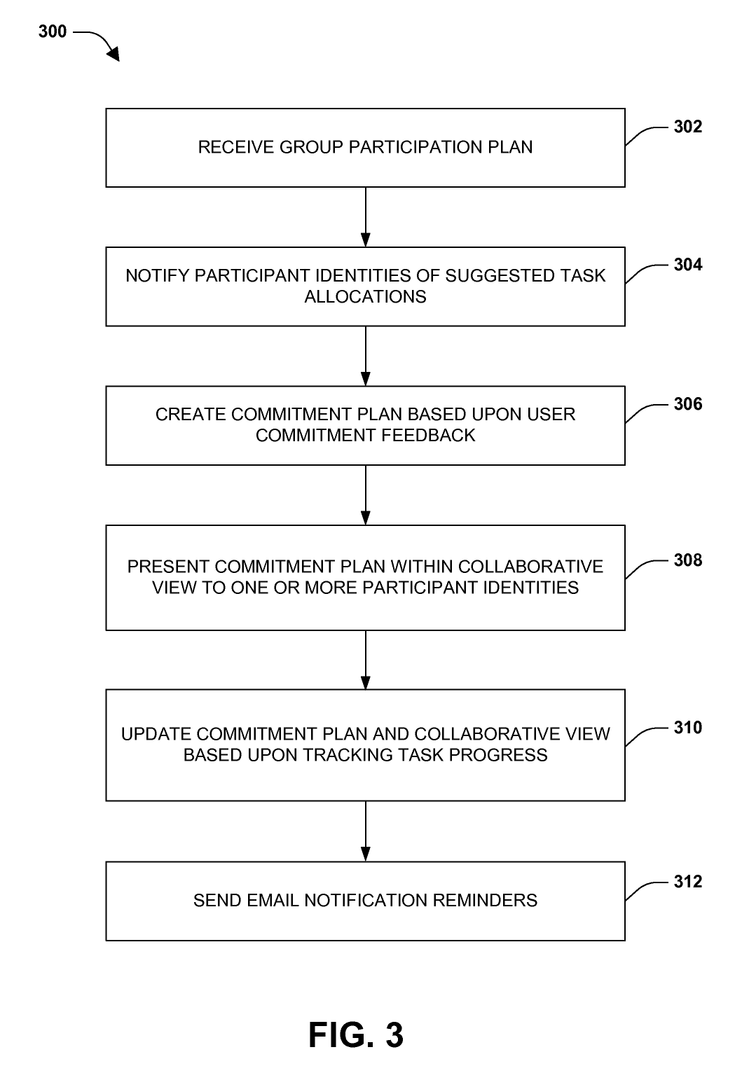

One embodiment of creating a collaborative view for a group participation plan is illustrated by an exemplary flow diagram 300 in FIG. 3. At 302, a group participation plan relating to an activity may be received. The group participation plan may comprise one or more tasks along with a user specified mapping of the one or more tasks to one or more participant identities. At 304, participant identities may be notified of suggested task allocations. The suggested task allocations may be derived from the user specified mapping. In one example, an email notification may be sent to a participant identity requesting the participant to commit to the one or more tasks allocated within the suggested task allocation. A user commitment feedback may be received from the participant regarding the suggested task allocation (e.g., the participant commits to the task, the participant declines the task, the participant modifies the task, etc.).

At 306, a commitment plan may be created based upon the user commitment feedback. It may be appreciated that the commitment plan may be revised based upon the user commitment feedback. For example, if a participant declines a task, then the task may be allocated to a different participant. Once the commitment plan is finalized, an email may be sent to the participant identities regarding their commitments. At 308, the commitment plan may be presented within a collaborative view to one or more participant identities. For example, the collaborative view may be accessible through a website that participants may access to view individual or group progress, update their progress, and/or view comments. The collaborative view may present a group total participation status, one or more participation statuses, and/or other information regarding the activity and tasks. This allows participants to view their outstanding participation (e.g., task progress), the amount of task progress particular participants may still owe, and/or progress of the group as a whole through a single dedicated user interface.

At 310, the commitment plan and/or collaborative view may be updated based upon tracking task progress. In one example, the collaborative view may allow an organizer of the activity may manually update the group total participation status, participation status of respective participant identities, and/or add comments to create peer pressure. In another example, a notification of payment to a third party service may be received, wherein the collaborative view may be updated based upon the progress determined from the notification (e.g., the participant's status and group status within the collaborative view may be updated based upon a participant reconciling a payment task with an online service). The organizer may receive automatic emails of participants intentions through the collaborative view and may manually update their status within the collaborative view, thus outstanding balances may be automatically recalculated. At 312, email notification reminders may be sent manually and/or automatically. For example, the collaborative view may allow an organizer to send emails through the collaborative view to participant identities.

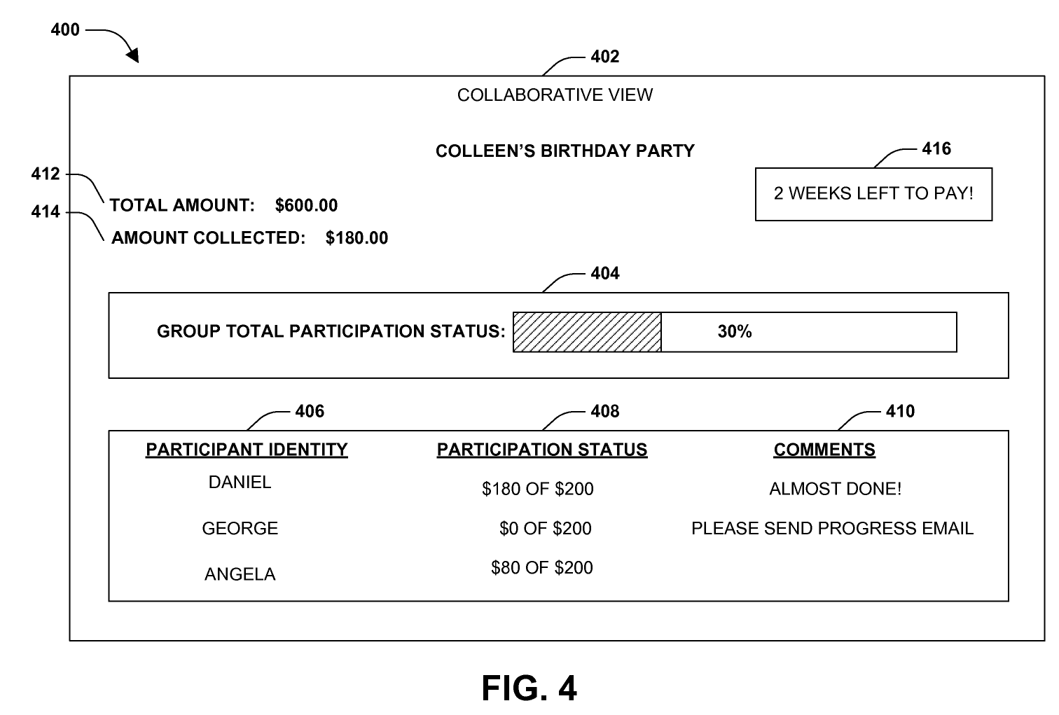

FIG. 4 illustrates an example 400 of a collaborative view. A collaborative view 402 may be presented within a computing environment (e.g., a mobile device, a web-base environment, a user interface application, etc.). The collaborative view 402 may correspond to a commitment plan created for an activity (e.g., “Colleen's Birthday Party”). The commitment plan may have allocated one or more tasks (e.g., collect a total of $600 for the birthday party) to one or more participant identities (e.g., Daniel's task is to pay $200). Within the collaborative view 402, a group goal 412 (e.g., collect $600) and/or a group total participation status 414 (e.g., $180 collected so far) may be presented. A group total participation status bar 404 may also be presented within the collaborative view 402 to provide a visual representation of the group total participation status 414. This allows participants to view and track the overall group progress within the collaborative view 402. It may be appreciated that other status indicators may also be presented, such as a pie chart, for example, and that the examples presented herein are not meant to be limiting (e.g., are not meant to limit the application to any one or more particular examples). Within the collaborative view 402, a time to completion notification 416 may be presented (e.g., “2 weeks left to pay!”) and/or other information regarding the birthday party and/or task progress.

Within the collaborative view 402, participant identities 406 along with their respective participant status 408 may be presented. For example, Daniel may have paid $180 out of his individual goal of $200, George may have paid $0 out of his individual goal of $200, and Angela may have paid $80 of her individual goal of $200. This allows participants to view and track not only their own participation status, but also participation statuses of other participants. This transparency of other participants' statuses may facilitate peer pressure to encourage timely participation and completion of individual goals. Peer pressure may also be created through comments 410 presented within the collaborative view 402. For example, an organizer may leave George a comment that it may be in his best interest to send a progress email to the organizer, thus creating peer pressure visible to all participants that George may be behind on this task. It may also be appreciated that email notifications may be sent to George and/or other participant entities regarding task progress (e.g., congratulations for completing all of your allocated tasks, please hurry up time is running out to complete your task, etc.). The comments 410 may also be used to encourage participants. For example, a comment “Almost Done!” may be displayed within the collaborative view 402 based upon the percentage of completion of Daniel's task.

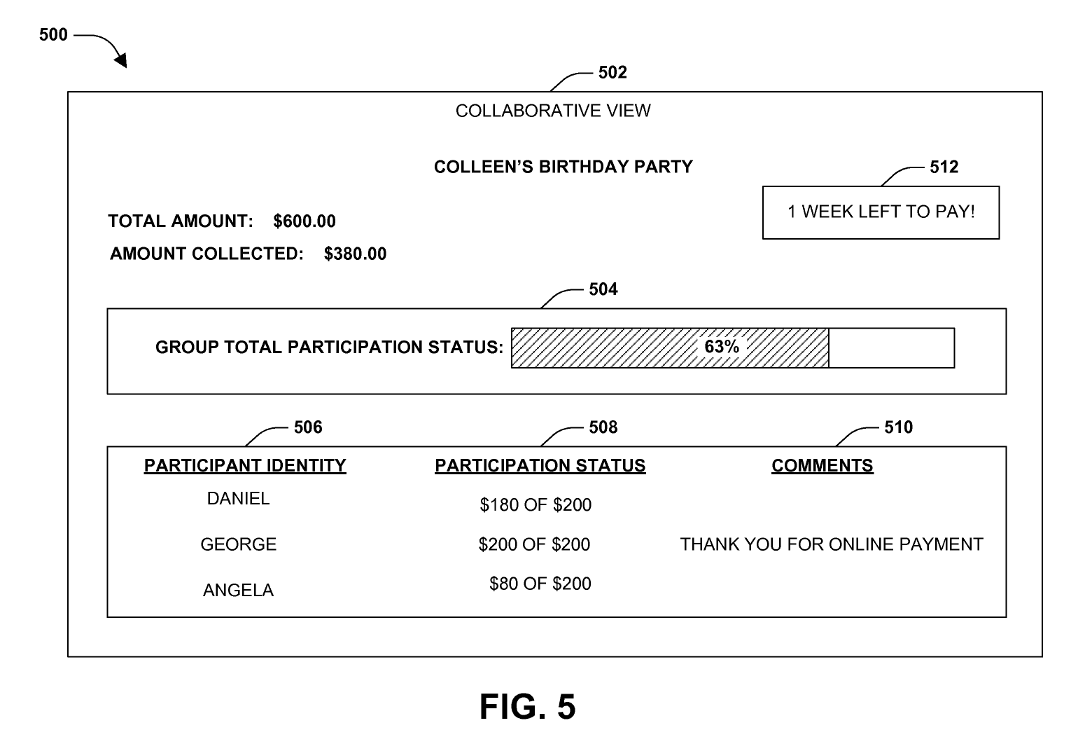

FIG. 5 illustrates an example 500 of a collaborative view. A collaborative view 502 (e.g., an updated version of the collaborative view 402 in FIG. 4). Within the collaborative view 502, a group total participation status bar 504 may be presented. The group total participation status bar 504 may visually represent the total progress of the group in completing all tasks related to an activity (e.g., “Colleen's Birthday Party”). Within the collaborative view 502, participant identities 506 along with their respective participant status 508 and comments 510 may be presented.

It may be appreciated that the collaborative view 502 (e.g., a time to completion notification 512, the group total participation status bar 504, participation status 508, comments 510, etc.) may be updated based upon progress notifications. For example, George may have submitted an online payment of $200 to a third party service (e.g., online money transfer, online service tracking, etc.). Upon receiving notification of the payment (e.g., from the third party service, from a user through email or text message, etc.), the collaborative view 508 may be updated. The participation status 508 relating to George may be updated to reflect George's task progress (e.g., $200 out of $200). The comments 510 relating to George (e.g., “Thank you for Online Payment”) may be automatically generated or manually inputted. The group total participation status may be updated to account for George's task progress (e.g., $380 collected so far). The group total participation status bar 504 may be updated to visually reflect the updated overall group progress. Due to the passing of time, the time to completion notification 512 may be updated (e.g., “1 Week Left to Pay”). Updating the collaborative view 502 allows participants to track and view the latest progress of themselves and the group.

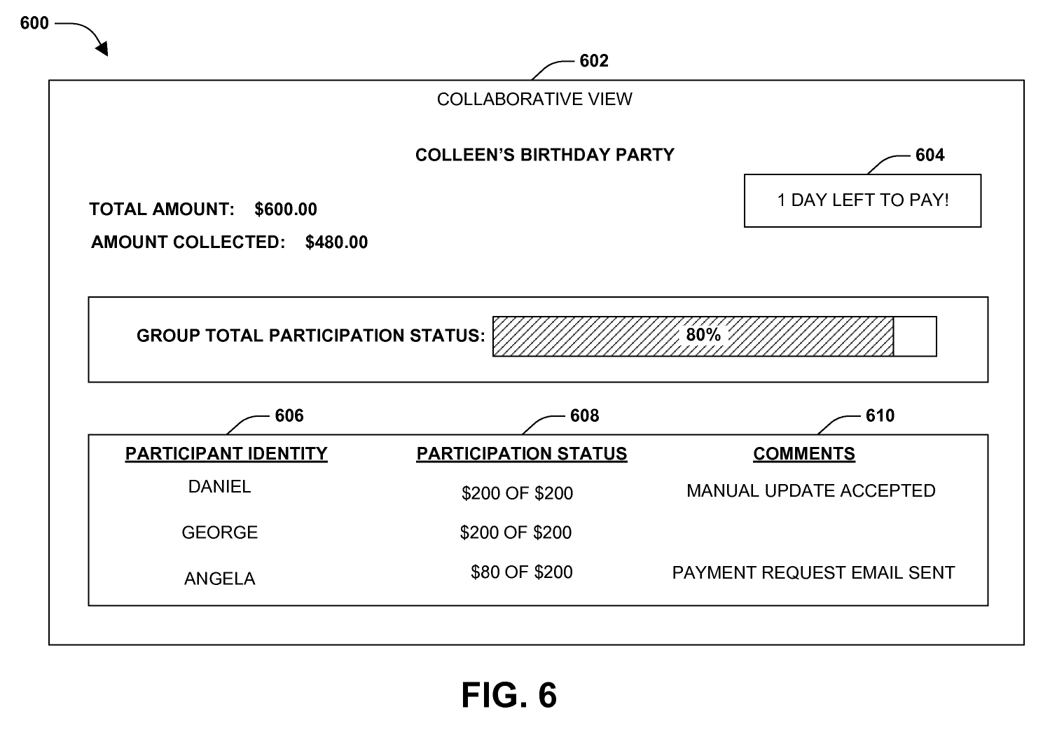

FIG. 6 illustrates an example 600 of a collaborative view. A collaborative view 602 (e.g., an updated version of the collaborative view 402 in FIG. 4 and/or the collaborative view 502 in FIG. 5). The collaborative view 602 may present information (e.g., a group total participation status, participant identities 606, participation status 608 of respective participant identities 606, comments 610, a time to completion notification 604, etc.) regarding an activity (e.g., “Colleen's Birthday Party”).

The collaborative view 602 may be updated based upon progress notifications (e.g., manual user input, notification of payment, email notification, etc.). In one example, the comments 610 relating to Angela may be updated to provide a notification that an email requesting payment from Angela was sent (e.g., an email notification of a web-based invoice for payment of a money based task). In another example, the comments 610 relating to Daniel may be updated to provide a notification that a manual update (e.g., Daniel changed his participation status to $200 out of $200 due to a payment) was accepted. Based upon the manual update, a group total participation status and/or a group total participation status bar may be updated to reflect Daniel's progress. In yet another example, an organizer of the activity may update the time to completion notification 604 to provide peer pressure upon the participants (e.g., a notification “1 Day Left to Pay!”).

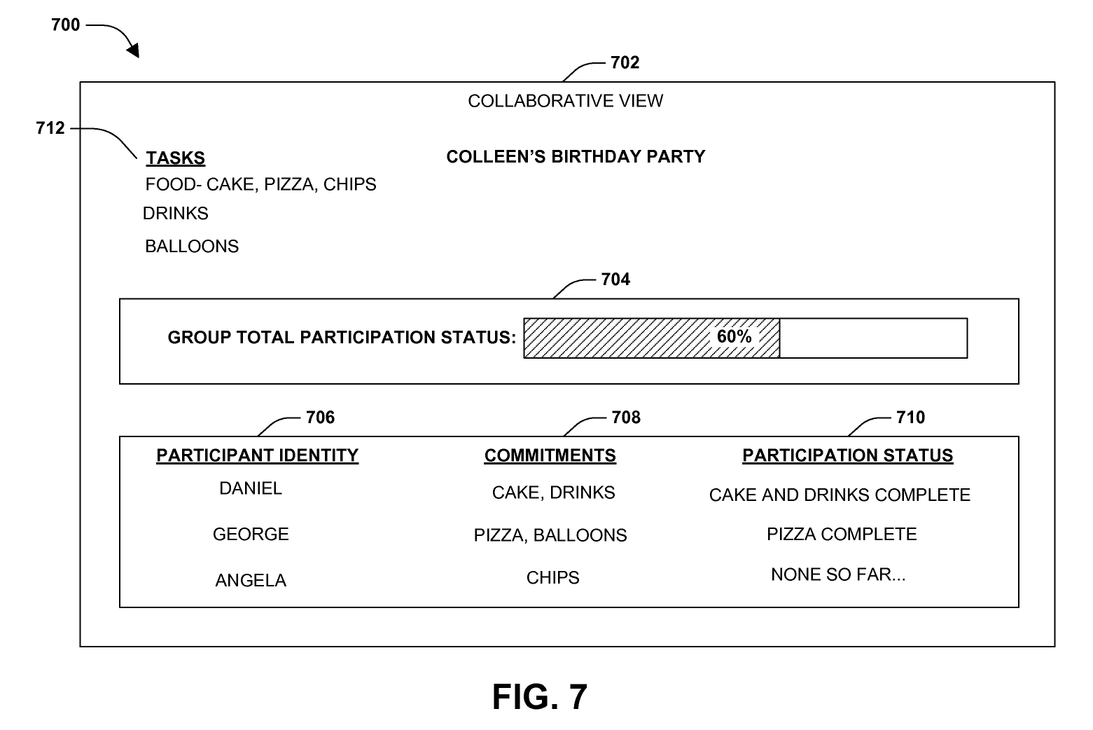

FIG. 7 illustrates an example 700 of a collaborative view. A collaborative view 702 pertaining to an activity (e.g., “Colleen's Birthday Party”) may be presented. The collaborative view 702 may correspond to a commitment plan (e.g., the commitment plan may be presented within the collaborative view). The commitment plan may involve one or more tasks (e.g., bring food, cake, pizza, chips, drinks, balloons, etc. for the birthday party) allocated to one or more participant identities (e.g., Daniel, George, Angela). For example, Daniel may be allocated the task of bringing cake and the task of bringing drinks, George may be allocated the task of bringing pizza and the task of bringing balloons, and/or Angela may be allocated the task of bringing chips.

Within the collaborative view 702, one or more tasks 712 may be presented along with a group total participation status bar 704 visually indicating the percentage of task completion (e.g., 60% of the one or more tasks 712 have been completed by participant identities). The collaborative view 702 may also comprise participant identities 706, commitments 708 or respective participant identities, and/or participation status 710 of respective participant identities 706.

In one example, a commitment plan may have allocated the task of bringing cake and the task of bringing drinks to Daniel. The commitments 708 allocated to Daniel may be displayed within the collaborative view 702. The participation status 710 corresponding to Daniel may indicate that the task of bringing cake and the task of bringing drinks are complete. In another example, a commitment plan may have allocated the task of bringing pizza and the task for bringing balloons to George. The participation status 710 corresponding to George may indicate that the task of bringing pizza is complete. In another example, a commitment plan may have allocated the task of bringing chips to Angela. The participation status 710 corresponding to Angela may indicate that no task progress has been completed so far. The collaborative view 702 allows the participants to view and track individual and overall group progress. Motivating participants (e.g., peer pressure through visible participation statuses) to complete tasks may be facilitated through the collaborative view 702. For example, Angela may be motivated to complete the task of bringing chips because she and other participants will be able to view her commitments and lack of progress through the collaborative view. It may be appreciated that although FIG. 7 relates to tracking discrete tasks (e.g., bringing chips), the collaborative view 702 may simultaneously track progress towards a number and/or other (cumulative) goal(s) (e.g., raised X of $200) as in FIG. 4-6.

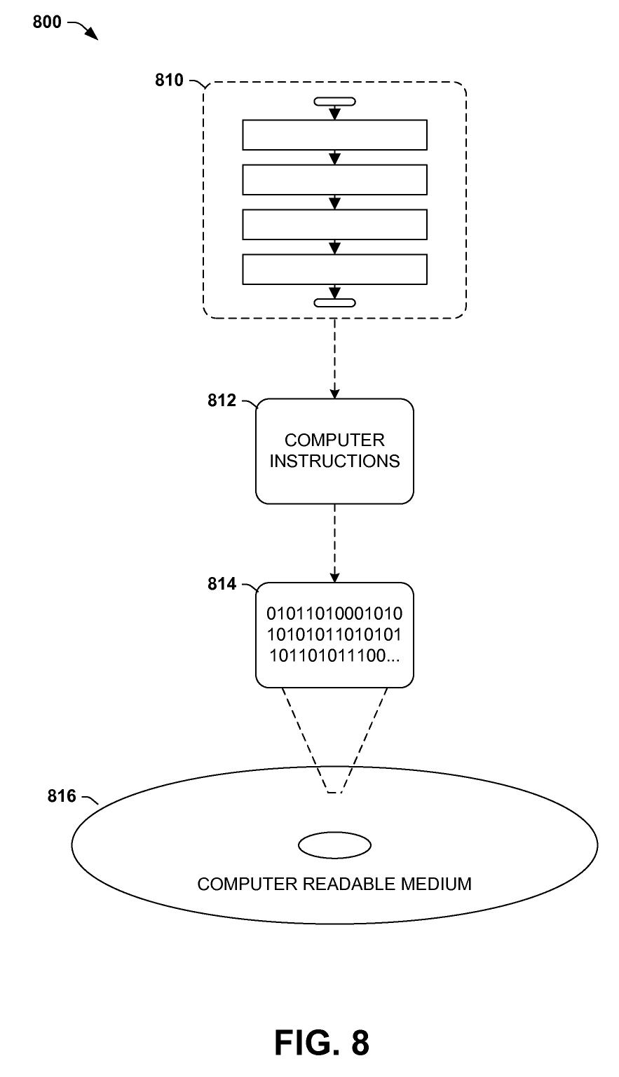

Still another embodiment involves a computer-readable medium comprising processor-executable instructions configured to implement one or more of the techniques presented herein. An exemplary computer-readable medium that may be devised in these ways is illustrated in FIG. 8, wherein the implementation 800 comprises a computer-readable medium 816 (e.g., a CD-R, DVD-R, or a platter of a hard disk drive), on which is encoded computer-readable data 816. This computer-readable data 814 in turn comprises a set of computer instructions 812 configured to operate according to one or more of the principles set forth herein. In one such embodiment 800, the processor-executable instructions 812 may be configured to perform a method 810, such as the exemplary method 100 of FIG. 1, for example. In another such embodiment, the processor-executable instructions 812 may be configured to implement a system, such as the exemplary system 200 of FIG. 2, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

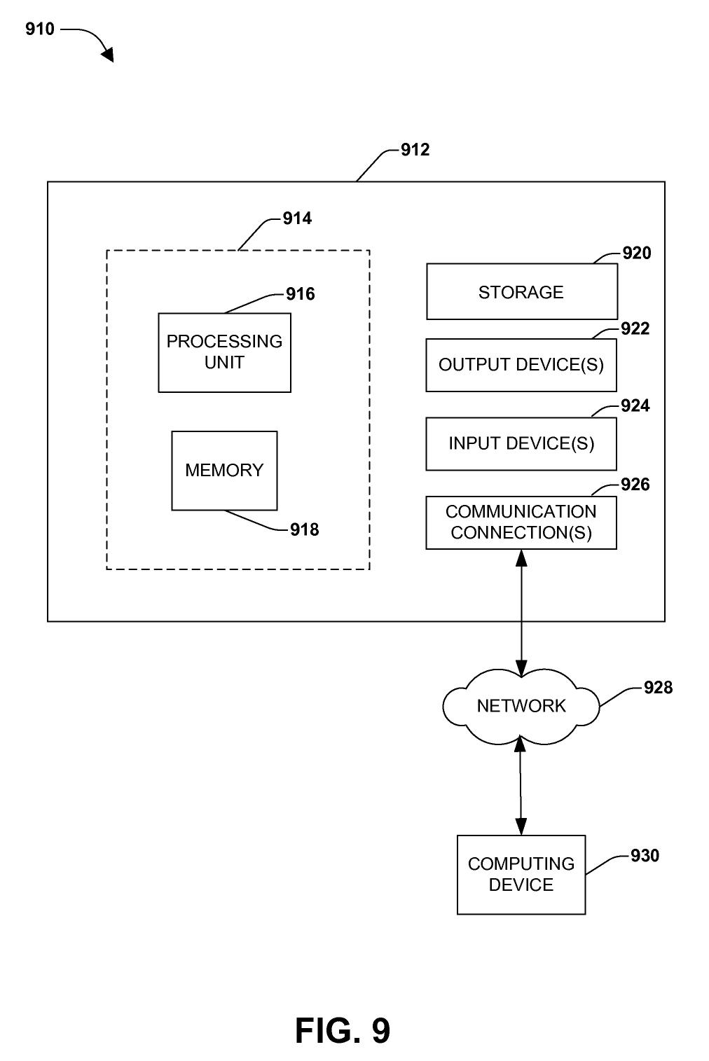

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 910 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912. In one example, output device(s) 922 may be a display configured or suitable for displaying the collaborative view 702 of FIG. 7.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via a network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for creating a collaborative view for a group participation plan comprising:
receiving a group participation plan comprising one or more tasks and one or more participant identities;
allocating one or more tasks to respective participant identities to create a commitment plan; and
presenting the commitment plan within a collaborative view.

2. The method of claim 1, the allocating one or more tasks comprising:
notifying a participant identity of a suggested task allocation; and
creating the commitment plan based upon user commitment feedback regarding the suggested task allocation.

3. The method of claim 1, comprising:
presenting within the collaborative view a group total participation status and a participation status of respective participant identities.

4. The method of claim 1, comprising:
updating the commitment plan based upon progress with regard to one or more tasks.

5. The method of claim 4, wherein the progress is determined based upon a notification of payment to a third party service.

6. The method of claim 4, wherein the progress is determined based upon manual user input.

7. The method of claim 4, wherein the progress is determined based upon a progress email received from a participant identity.

8. The method of claim 4, comprising:
notifying an organizer of the updated commitment plan.

9. The method of claim 1, comprising:
sending an email notification of a participation status to one or more participant identities.

10. The method of claim 1, comprising:
sending an email notification comprising a web-based invoice for payment of a money based task to one or more participant identities.

11. The method of claim 1, wherein the collaborative view is presented to one or more participant identities within a web-based environment.

12. A system for creating a collaborative view for a group participation plan comprising:
an allocation component configured to:
receive a group participation plan comprising one or more tasks and one or more participant identities; and
allocate one or more tasks to respective participant identities to create a commitment plan; and
a presentation component configured to present the commitment plan within a collaborative view.

13. The system of claim 12, comprising:
an email component configured to send an email notification of a participation status to one or more participant identities.

14. The system of claim 12, comprising:
an update component configured to update the commitment plan based upon progress with regard to one or more tasks.

15. The system of claim 12, the allocation component configured to:
notify a participant identity of a suggested task allocation; and
create the commitment plan based upon user commitment feedback regarding the suggested task allocation.

16. The system of claim 12, the presentation component configured to present within the collaborative view a group total participation status and a participation status of respective participant identities.

17. The system of claim 12, the presentation component configured to present the collaborative view to one or more participant identities within a web-based environment.

18. The system of claim 14, the update component configured to update one or more participation statuses and a group total participation status based upon progress with regard to one or more tasks.

19. The system of claim 14, the update component configured to determine the progress based upon at least one of:
manual user input within the collaborative view;
notification of payment to a third party service; and
notification from a participant identity of the progress.

20. A system for creating a collaborative view for a group participation plan comprising:
an allocation component configured to:
receive a group participation plan comprising one or more tasks and one or more participant identities;
allocate one or more tasks to respective participant identities to create a suggested task allocation; and
create the commitment plan based upon user commitment feedback regarding the suggested task allocation;
a presentation component configured to present the commitment plan within a collaborative view;
an email component configured to send an email notification of a participation status to one or more participant identities; and
an update component configured to update the commitment plan, one or more participation statuses and a group total participation status based upon progress with regard to one or more tasks.
